(19) United States
(12) Patent Application Publication
(10) Pub. No.: US 2015/0181310 A1
(43) Pub. Date: Jun. 25, 2015

(54) SYSTEM AND METHOD FOR PRESENTING ADVERTISEMENT PLAYOUT SUMMARIES IN AN INTERACTIVE DISPLAY

(71) Applicant: SeaChange International, Inc., Acton, MA (US)

(72) Inventors: Kenneth S. Hancock, Merrimack, NH (US); Aseem Bakshi, Stamford, CT (US)

(73) Assignee: SeaChange International, Inc., Acton, MA (US)

(21) Appl. No.: 14/138,984

(22) Filed: Dec. 23, 2013

(51) Int. Cl. H04N 21/81; H04N 21/234

(52) U.S. Cl. CPC H04N 21/812; H04N 21/23424

(57) ABSTRACT

Systems, methods, computer program products and apparatus are described for presenting an advertisement playout summary in an interactive display, that involve collecting individual playout statistics corresponding to playout of advertisements from at least one advertising insertion computer system; organizing the individual playout statistics into groups, each group having a group identifier; calculating aggregated playout statistics for each group, the aggregated playout statistics comprising a first statistic calculated for the group; generating display information for a displayable grid of blocks, each block displays the group identifier and at least one of the aggregated playout statistics for a respective group, wherein the size and position of the block in the grid depends on the first statistic; and transmitting the display information to a client device to display the grid. The color of a block corresponding to a respective group can depends on a second statistic.

### FIELD OF INVENTION

The invention relates to a system and method for presenting information, namely advertisement playout summaries associated with a broadcast television or other linear video delivery system, in an interactive display, and particularly to the format of the interactive display for drawing one's attention to particular ad playout summaries at a given monitoring level.

### BACKGROUND

In the U.S., television advertising is considered one of the most effective mass-market advertising methods. Advertising not only provides funding for most privately owned television networks but also serves as a critical tool for companies and businesses to promote products and services. Linear television is broadcast television that has a predefined schedule (e.g., broadcast television over a cable television infrastructure or other embodiment). The majority of television advertisements for linear television consist of brief advertising spots, ranging in length from a few seconds to several minutes. Spot Television (“Spot TV”), for example, is the purchase of commercial time on a market-by-market basis.

Advertisement (“ad”) insertion computer systems are used for handling the insertion of video advertisements, such as commercials, within advertising opportunities of broadcast television programming or other linear video programming. An example of such a system is SeaChange® Infusion™ Spot Manager from SeaChange International, Inc. having is corporate headquarters in Acton, Mass. Ad insertion computer systems are typically located at head ends of multi-system operators (MSO) and perform ad insertion according to a predetermined schedule in which the video advertisements are assigned to a particular time slot (e.g., a commercial break).

Situations can arise in which errors occur in the playout of such video advertisements. For example, an ad insertion computer system may receive an ad insertion schedule that assigns a particular advertisement for insertion during a specific time slot or other “spot,” but fails to receive the corresponding video for the advertisement to playout. Another example of a playout error can occur in which an ad insertion computer system receives conflicting schedules in which more than one advertisement are assigned to the same time slot for playout. Still other examples of playout errors can occur due to hardware/software failures and/or other scheduling errors (e.g., no advertisement is assigned to a particular timeslot).

### SUMMARY OF THE INVENTION

Embodiments of the invention are directed to methods, computer program products and computerized server apparatus for presenting an advertisement playout summary in an interactive display, that comprise structure, steps and instructions, respectively, for collecting individual playout statistics corresponding to playout of advertisements from at least one advertising insertion computer system; organizing the individual playout statistics into groups, each group having a group identifier; calculating aggregated playout statistics for each group, the aggregated playout statistics comprising a first statistic calculated for the group; generating display information for a displayable grid of blocks, each block displays the group identifier and at least one of the aggregated playout statistics for a respective group, wherein the size and position of the block in the grid depends on the first statistic; and transmitting the display information to a client device to display the grid. The aggregated playout statistics can further comprise a second statistic for each group, where the color of the block corresponding to a respective group depends on the second statistic.

In any of the foregoing embodiments, the groups can be channel groups and the aggregated playout statistics for each channel group correspond to a single broadcast network. The groups can be zone groups and the aggregated playout statistics for each zone group corresponds to the aggregated playout statistics for a plurality of channel groups or a plurality of broadcast networks. The groups can be market groups and the aggregated playout statistics for each market group corresponds to the aggregated playout statistics for a plurality of zone groups. The groups can be region groups and the aggregated playout summary statistics for each region group corresponds to the aggregated playout summary statistics for a plurality of zone groups.

Embodiments of the invention can further comprise structure, steps and instructions, respectively, for defining a plurality of levels; organizing the individual playout statistics into groups at each level, each group at each level having a group identifier; calculating the aggregated playout statistics for each group at each level, the aggregated playout statistics comprising the first statistic calculated for the group; receiving a request to display the aggregated playout statistics for the groups at a selected level; generating the display information for the displayable grid of blocks for the selected level, each block displays the group identifier and at least one of the aggregated playout statistics for a respective group, wherein the size and position of the block in the grid depends on the first statistic; and transmitting the display information to the client device to display the grid.

Other aspects of the invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention as well as the invention itself, will be more fully understood from the follow description of various embodiments, when read together with the accompanying drawings.

FIG. 1 is a system diagram illustrating an environment in which embodiments of the invention can be implemented.

FIG. 2 is a flow diagram illustrating a method for generating an interactive display for presenting aggregated playout statistics according to one embodiment.

FIG. 3 is an example of an interactive display having a format for presenting aggregated playout statistics, or playout summaries, according to one embodiment.

FIG. 4 is a flow diagram illustrating a method for generating an interactive display having a format for presenting for aggregated playout statistics according to another embodiment.

FIG. 5 illustrates graphical representations of exemplary inter-relationships amongst groups at different levels for monitoring ad playout statistics within a broadcast television or other linear video delivery system.

FIGS. 6A and 6B are examples of the interactive display having a format for presenting aggregated playout statistics, or playout summaries, at different levels according to one embodiment

FIG. 7 is an exemplary graphical user interface or dashboard screen for manipulating the interactive display.

### DETAILED DESCRIPTION

Systems, methods, computer program products and computerized server apparatus are described herein for presenting information, particularly aggregated ad playout statistics (also referred to herein as “ad playout summaries”), in an interactive display. More particularly, the interactive display can present ad playout summaries associated with different groups (e.g., networks, channel, zones, markets, regions) in the form of a displayable grid of blocks, where the significance, priority, severity or other value associated with the ad playout summary for a particular group can be represented by the size, position and color of the blocks, or any combination thereof. Accordingly, the display format generated for the interactive display enables a user to readily identify playout error conditions or other issues in groups requiring attention.

Further, the displayable grid can show the ad playout summaries associated with groups at particular monitoring levels. For example, at one such monitoring level, each block within the grid can provide the respective ad playout summary for a particular network (e.g., CNN, ESPN, etc.). At other monitoring levels, the ad playout summaries for each network can be aggregated for display in a block that corresponds to a specific zone, market or region, for example. Other hierarchical relationships can be defined between groups and levels, so that an end user can interact with the display to analyze ad playout summaries of groups at different monitoring levels. Accordingly, this interactive capability can be used by an operator to determine the scope of a particular playout issue by interacting with the display to narrow and/or broaden the monitored view of ad playout summaries at different levels.

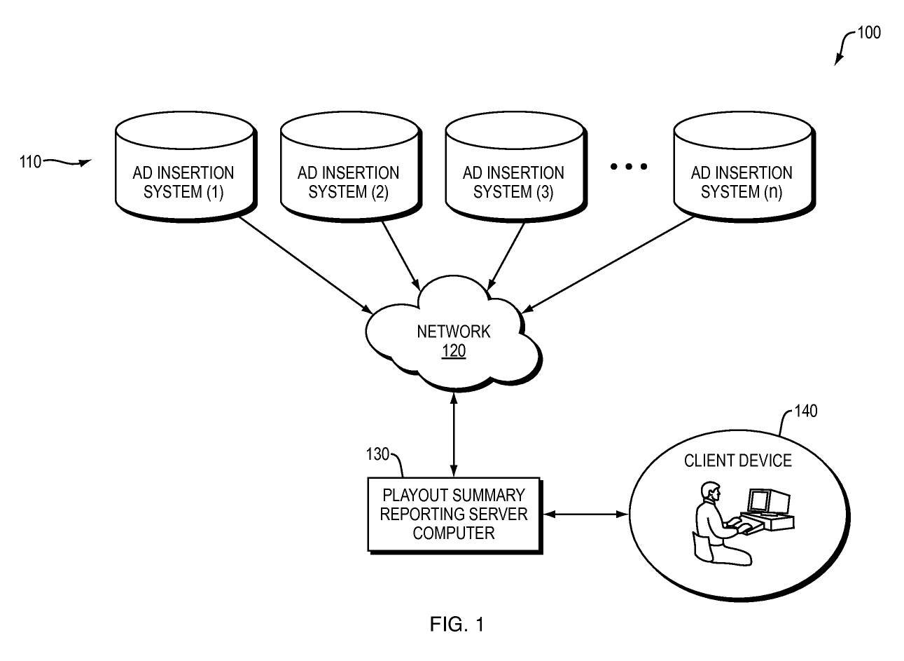

FIG. 1 is a system diagram illustrating an environment in which embodiments of the invention can be implemented. The system 100 includes a plurality of advertisement (“ad”) insertion computer systems 110 and a playout summary reporting server 130 coupled to a network 120. The network can be the Internet or any other public or private network through which data can be transmitted between the ad insertion computer systems 110 and the playout summary reporting server 130. The ad insertion computer systems 110 can be positioned at a number of diverse geographic locations, such as head ends of multi-service operators (MSOs). Also shown is a client device 140 that communicates with the playout summary reporting server 130 over a network, such as network 120. The client device 140 can be a desktop computer, laptop or other mobile device that includes or is coupled to a display device through which to present graphical data.

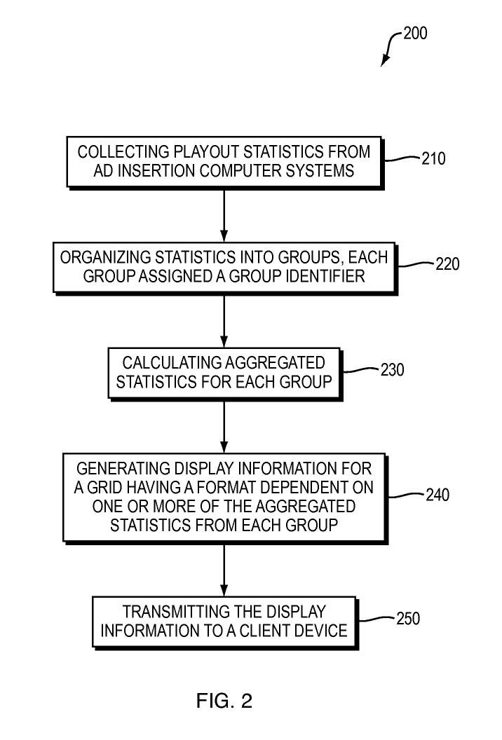

FIG. 2 is a flow diagram illustrating a method for generating an interactive display for presenting aggregated playout statistics according to one embodiment.

At 210, individual playout statistics are collected by the playout summary reporting server 130 from one or more of the ad insertion computer systems 110. Playout statistics, which can include past, present, future or at risk playout statistics, can be collected and stored by the playout summary reporting server 130 for a configurable time—e.g., up to 24 hours. Examples of such playout statistics can include run rate and future conflicts. A run rate is a percentage representing the ads that have successfully run over the configurable time frame. Future conflicts are playout errors that will occur if no responsive action is done to correct the conflict before the spots associated with them are scheduled to play. Other types of playout statistics can also be collected.

At 220, the collected individual playout statistics are organized by the playout summary reporting server 130 into groups, each group being assigned a group identifier. For example, without limitation, individual playout statistics can be grouped according to networks, channels and user-defined zones, markets and regions.

At 230, the playout summary reporting server 130 calculates aggregated playout statistics for each group. For example, a total or average number of future conflicts for each group can be calculated from the individual future conflicts. As another example, a total or average run-rate can be calculated for each group. These playout summaries can be calculated by the playout summary reporting server 130 continually, in real-time, as information is collected from various ad insertion systems 110. These playout summaries can also calculated on demand in response to a user request received from the client device 140.

Other aggregated playout statistics can also be calculated. For example, where a scheduled advertisement has not yet been placed onto a particular ad insertion computer system, that advertisement will fail to play, resulting in a loss of advertising revenue unless corrected. Such lost revenue typically depends on the particular broadcast network in which the failed ad was intended for placement. Accordingly, another aggregated playout statistic can represent such revenue at risk of being lost. Such a statistic takes into account that fewer ad playout errors on high-value networks (ESPN, CNN) can be more significant than more at risk errors on low-value networks (“Bob's channel”) or low-value zones having fewer subscribers.

At 240, the reporting server 130 generates display information for a grid having a format dependent on one or more of the aggregated statistics from each group. At 250, the display information is transmitted to the client device to display the grid.

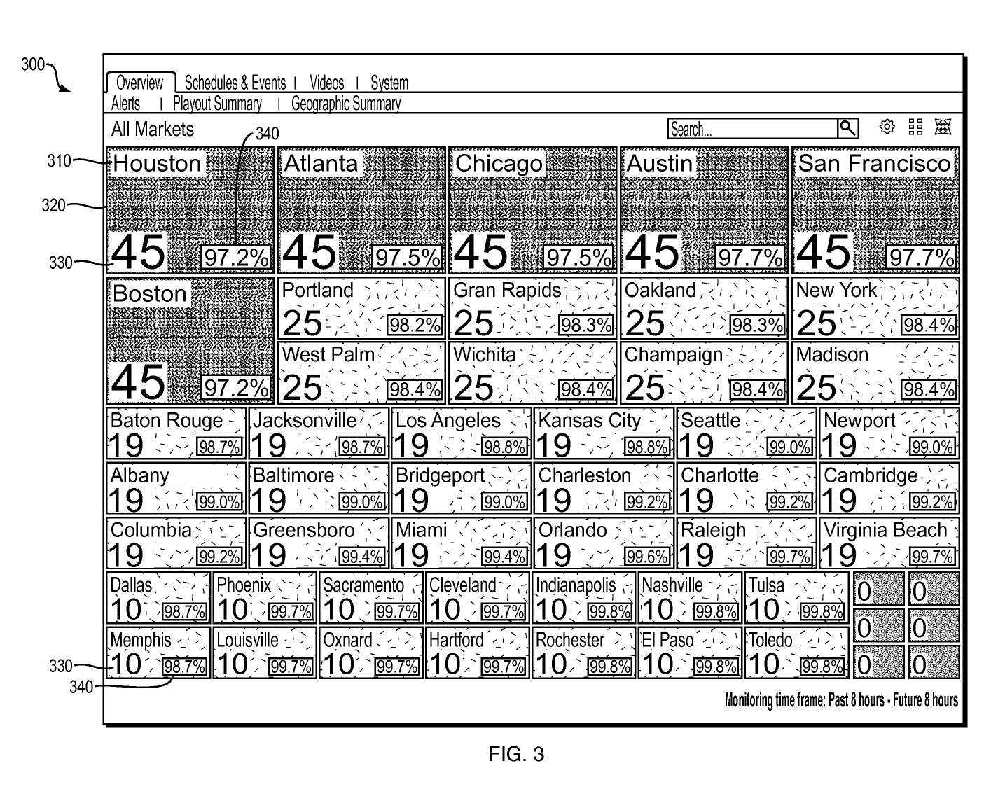

FIG. 3 is an example of an interactive display having a format for presenting aggregated playout statistics, or playout summaries, according to one embodiment. As shown, the interactive display comprises a grid 300, where each block 320 of the grid displays a group identifier 310 and one or more of the aggregated playout statistics for that group. As shown, the displayed aggregated playout statistics are future conflicts 330 and run rate 340. In addition, to displaying such statistics, the display format of each block depends on the value of at least one of the aggregated playout statistics for a corresponding group.

In this example, the size and position of each block depends on the value of the aggregated number of future conflicts 330 and the color of the each block depends on the value of aggregate run rate 340. Preferably, as the severity associated with such aggregated playout statistics increases for a particular group, the more significance it obtains in the display in order for the user to readily identify playout errors. For example, with the highest number of future conflicts 330 being in the Houston, Atlanta, Chicago, Austin, San Francisco and Boston markets, the corresponding blocks are shown as being relatively larger in size and positioned at or near the top of the grid. The blocks can be positioned at other desired positions for drawing attention to them (e.g. center of the grid). The block sizes can be configured to correspond to a specific value or range of values for future conflicts 330. Likewise, different block colors can be configured to correspond a specific value or range of values for run rates 330. For example, the groups having run rates in a low range can be shown in the color red to indicate the greater severity, yellow for groups having run rates in a medium range and green for groups having run rates in a high range. The grid can also have size, color, and/or position variability that fluctuates based on the values of any other configured set of aggregated playout statistics.

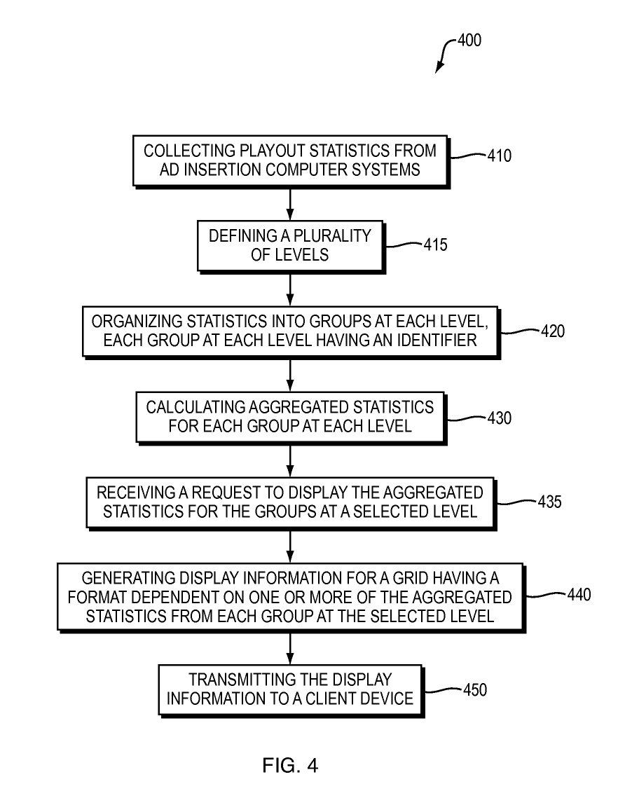

FIG. 4 is a flow diagram illustrating a method for generating an interactive display having a format for presenting for aggregated playout statistics according to another embodiment. In this embodiment, the interactive display can present a grid of blocks representing groups of aggregated playout statistics at different monitoring levels and can provide the ability to browse between groups at different levels based on defined relationships therebetween.

At 410, individual playout statistics are collected by the playout summary reporting server 130 from one or more of the ad insertion computer systems 110.

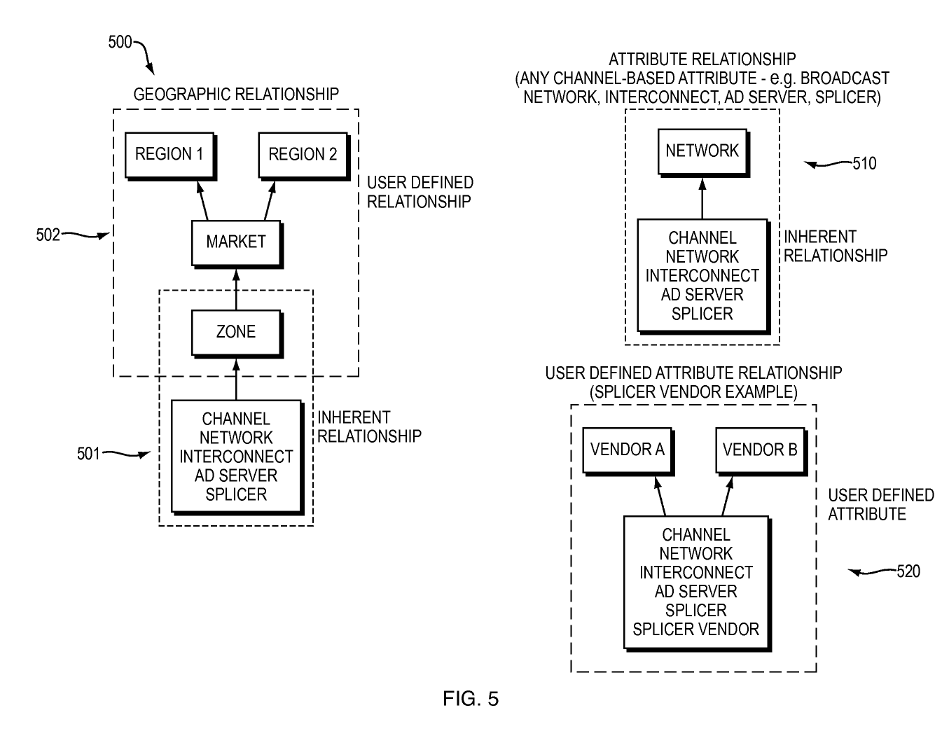

At 415, a plurality of monitoring levels is defined by the reporting server 130. Such levels and the interrelationship between groups at each level can be predefined and read from a database. Alternatively, such level information can be customized by the user from the client device 140. Preferably, groups at one defined level are logically connected to one or more groups at a next defined level to form a hierarchal relationship between groups at different levels. Defining such interrelationships enables a user to generate an interactive display through which to view the aggregated playout statistics for groups at one level and to drill down into one or more lower levels to view the aggregated playout statistics of groups logically connected to a group in that higher level. FIG. 5, as described further below, illustrates graphical representations of exemplary inter-relationships amongst groups at different levels for monitoring ad playout statistics within a broadcast television or other linear video delivery system.

At 420, the collected individual playout statistics are organized by the playout summary reporting server 130 into groups at each level, where each group is assigned a group identifier.

At 430, the playout summary reporting server 130 calculates aggregated playout statistics for each group at each level.

At 435, the playout summary reporting server 130 receives a request from the client device 140 to display the aggregated playout statistics for the groups at a selected level. Such a request can be received in response to a user activating a block within the grid (e.g., via mouse click) to view aggregated playout statistics associated with that block at a next level up or down within the hierarchy of levels as described in FIG. 5 below.

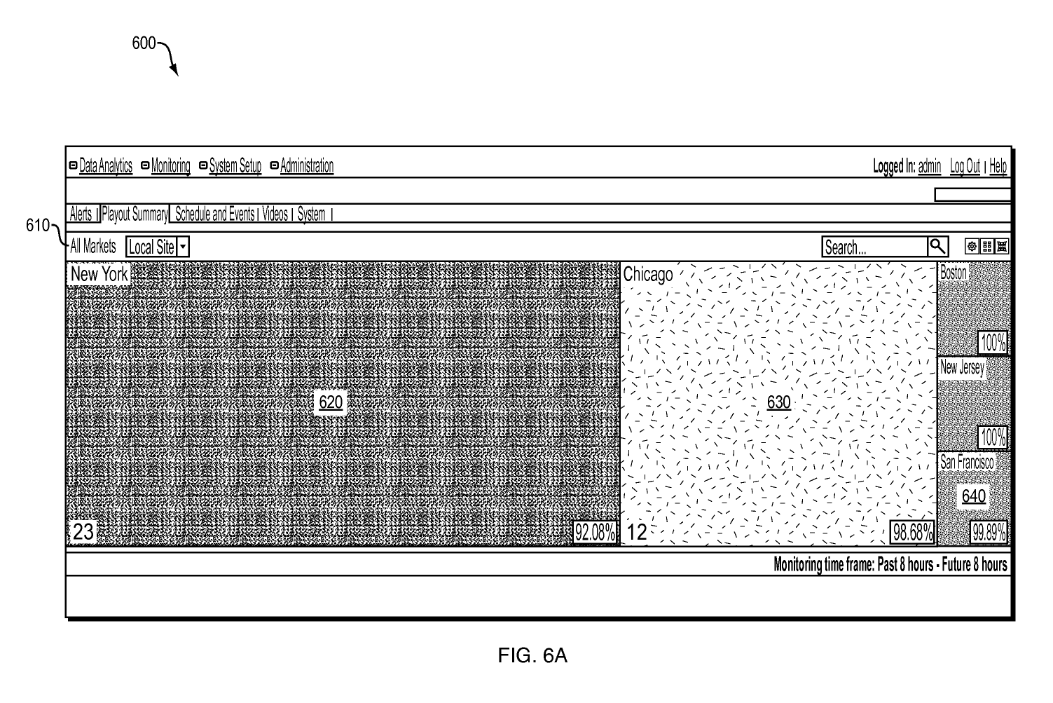

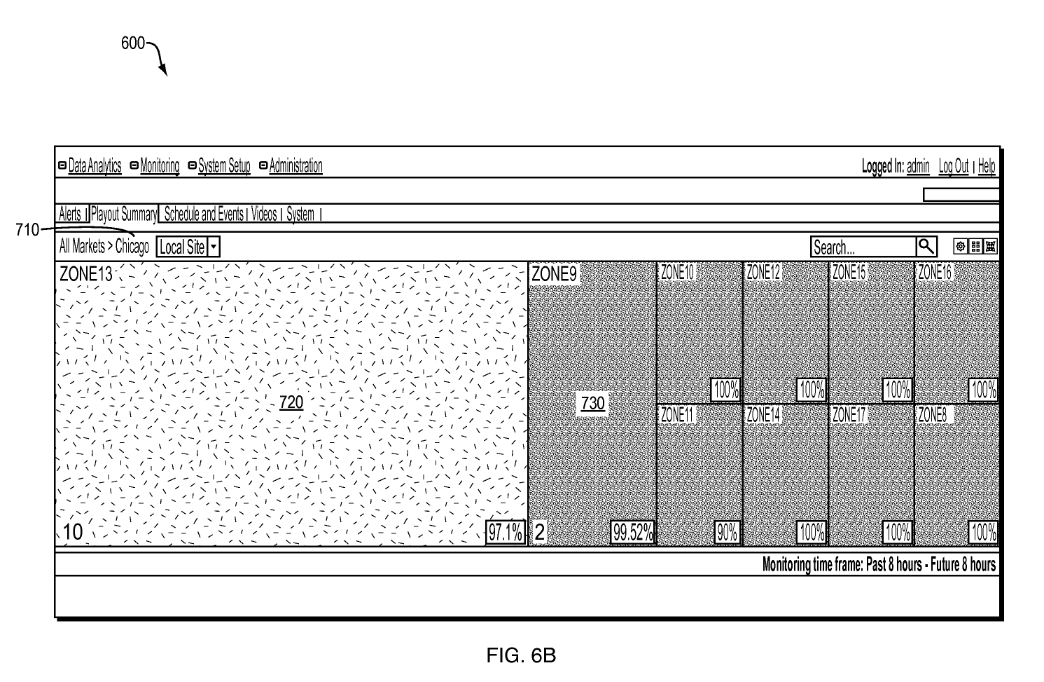

At 440, the reporting server 130 generates display information for a grid having a format dependent on one or more of the aggregated statistics from each group at the selected level. Examples of such a grid are shown and described above with respect to FIG. 3 and below with respect to FIGS. 6A-6C. At 450, the display information is transmitted to the client device to display the grid.

FIG. 5 illustrates graphical representations of exemplary inter-relationships amongst groups at different levels for monitoring ad playout statistics within a broadcast television or other linear video delivery system.

At 500, the hierarchy of monitoring levels, from top to bottom, includes region, market, zone and channel and the interrelationships between the groups at different levels are geographic. As shown, there can be an inherent relationship between groups of one level to groups of a next level. Specifically, at 501 of the hierarchy, there is an inherent relationship between a channel and a zone. A channel refers to a specific instance of a broadcast network, or a linear feed of content (or programming) from a content provider. ESPN and CNN are examples of networks. A zone is a group of channels associated with a geographically distinct area (e.g., towns or municipalities) for a set of television subscribers. A zone can also be any arbitrary grouping of subscribers, including demographic groupings. Accordingly, there is an inherent, one-to-one relationship between a channel and a zone.

Also shown at 500, the hierarchy can be expanded to further include user-defined relationships between groups of one level to groups of a next level. For example, at 502 of the hierarchy, the user can define geographic interrelationships between groups of zones, markets and regions. Market, region, and zone are all terms that pertain to areas of operation and correspond to groups of channels served by one or more ad insertion computer systems. For example, as discussed above, a zone is a group of channels, a market is a user-defined group of zones and a region is a user-defined group of markets (e.g., North, South, Southeast). Preferably, there is a one-to-one relationship is defined between a zone and a market. However, regions can be defined to overlap. According, as shown at 500, a single market can include all or part of multiple regions and a zone within that market can be logically associated with more than one region.

As may be apparent by these groupings, these groupings develop a hierarchy where at the top level there may be a region which breaks down into a collection of markets or zones. At the next level the markets and/or zones breaks down into a collection of zones in a geographical area. At the next level, the zones break down into a collection of networks in a geographical area. At the final level, the group of networks can be broken down into individual networks to be viewed independently of each other for a more in-depth look into the statistical information. These levels are therefore defined as part of the system, such that when the groups are created, they can be sorted into these levels such that the display can be set up to show the aggregated playout statistics of groups at these different levels. In this manner, the system 100 allows the user to drill down from the highest level to the lowest level to view the pertinent information. Again, when a user chooses to view the summary of information by organizing groups of channels by network, zone, market or region, problems that may only involve the originating broadcast network or an entire region become more readily apparent by viewing the proper level of information.

At 510, a hierarchy of monitoring levels is shown in which the interrelationships between groups at different levels are based on an inherently shared attribute. In this example, data is collected and organized into channel groups at the channel level by broadcast network (e.g. ESPN channel group, CNN channel group). Accordingly, when the aggregated playout statistics for a particular broadcast network as presented in a block of the interactive display suggests a problem (e.g., low future conflicts), the operator can click on the block within the grid to drill down to view aggregated playout statistics for that network at the channel level in order to determine on which channels (and thus on which ad insertion computer systems) such programs are being experienced. Alternatively, instead of network, channels can be groups by the splicer that inserts the advertisements into the broadcast network stream. Sustained differences in run rates between different splicers can be an indication of different issues, including differences in between splicers from different manufacturers or differences in software configurations in splicers from the same manufacturer.

At 520, a hierarchy of monitoring levels is shown in which the interrelationships between groups at different levels are based on a shared user-defined attribute. In this example, data is collected and organized at the channel level into channel groups by splicer vendors (e.g. Vendor A, Vendor B). Accordingly, when the aggregated playout statistics for a particular channel group as presented in a block of the interactive display suggests a problem (e.g., future conflicts), the operator can browse up the hierarchy to the vendor level to determine whether other channel groups serviced by the same splicer vendor are experiencing programs.

FIGS. 6A and 6B are examples of the interactive display having a format for presenting aggregated playout statistics, or playout summaries, at different levels according to one embodiment. FIG. 6A is an example of the interactive display 600 at a market level 610. As shown, the aggregated playout statistics for a number of market groups are presented in blocks 620, 630 and 640. Specifically, block 620 presents a low run-rate (92.08%) and high future conflicts (23) for the New York market relevant to the statistics shown in the blocks of the other market groups. Accordingly, block 620 is shown relatively larger in size than the other blocks and positioned at the top left-hand corner to provide a visual indication of the severity associated with the high aggregated number of future conflicts. Furthermore, the low run rate is associated with a different color (e.g., red) than in the other blocks. Block 630, which presents the aggregated playout statistics for the Chicago market, is presented with a lighter color (e.g., yellow), having a smaller size and positioned to the right of block 620. Accordingly such graphical elements provide a visual indicator which suggests the issues suggested by the statistics in the Chicago market are not as urgent as that those for the New York market. Regarding the other three markets, the aggregated statistics are shown in small blocks 640 having another color (e.g., green) to the far right, suggesting that little to no issues with ad insertion in those markets.

The display level may be initially selected by the user from the client device 140 through a drop down on the interactive display or by the user clicking on a block in the grid. For example, in FIG. 6A, if the user wanted to select the next level down, i.e., drill down to the next level, to determine the source of the large number of future conflicts in the Chicago market, the user could select the Chicago block 630 on the grid 600 and go to the lower level showing the zones associated with the Chicago market, as shown in FIG. 6B.

FIG. 6B is an example of the interactive display 600 of the Chicago market at the zone level 710. By virtue of the larger sizes and respective positions of blocks 720 and 730, the user can visually determine that the zones in the Chicago market that are primarily experiencing the future conflicts is zone groups ZONE13 and ZONE9. Specifically, ZONE13 is associated with 10 future conflicts and ZONE9 is associated with 2 future conflicts. Whereas none of the other zone are exhibiting any future conflicts, the sume of the conflicts in these two zones comprise the total number of future conflicts (12) for the Chicago market as shown in block 630 of FIG. 6A. Further, based on the differences in color, the user can visually determine that the primary zone experiencing a significant number of low run rate issues is in ZONE13 (block 720), which has a different color (e.g, yellow) than the other blocks (e.g., green). Accordingly, the user can readily determine that attention should be given to ZONE13 and ZONE9. The user may then wish to drill down to the next level, e.g., network level (not shown), to determine whether the issues are attributable to a specific network.

Although the examples of FIGS. 6A and 6B are described in the context of viewing aggregated playout statistics originating at the market level and drilling down into the lower zone level, it is also possible to perform such browsing in reverse order (e.g., from a lower level to an upper level). For example, the user can start at a network level and browse upward to determine if a particular issue is related or spread across zones, markets or regions. Accordingly, by drilling up or down, interactive displays presented to the user by the playout summary reporting server allows the user to determine how the information interconnects and where the issues may truly lie. Again, a different view point may make the issues easier to determine and enhance the user's pattern recognition various issues across a plurality of ad insertion systems.

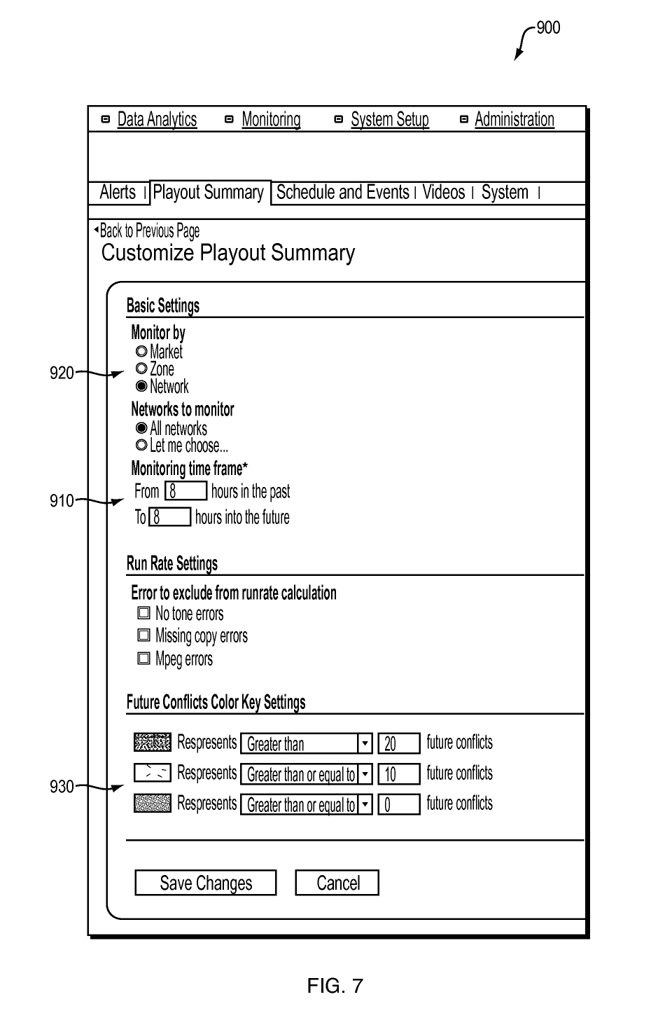

FIG. 7 is an exemplary graphical user interface or dashboard screen for manipulating the interactive display. As described above, the user can define interrelationships, define attributes, and the user can also be allowed to customize the display to zero in on pertinent information or to enhance issue pattern recognition. FIG. 7 shows an example graphical user interface 900 for such customization. For example, the user can choose to zero in on a particular time frame 910 by limiting or expanding the number of hours from which the statistics are collected, aggregated and displayed in order to help determine when and where an issue may have begun. Alternatively, or in conjunction with limiting the time frame, the user can choose to set which levels are monitored. Additionally, the user may choose when to highlight a group 930 by selecting when a group receives a different color, size or position in the grid display. These are merely examples, however, and another embodiment could incorporate further customization ability for the user to allow for more in depth pattern and issue spotting.

The above-described techniques can be implemented in digital electronic circuitry, or in computer hardware, firmware, software, or in combinations of them. The implementation can be as a computer program product, i.e., a computer program tangibly embodied in a machine-readable storage device, for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network.

Machine-readable storage devices suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks. Communication networks can also all or a portion of the PSTN, for example, a portion owned by a specific carrier.

The computing system can include clients and servers. A client and server are generally remote from each other and typically interact through a communication network. The relationship of client and server arises by virtue of computer programs running on the respective computers and having a client-server relationship to each other.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of presenting advertisement playout summary in an interactive display, comprising:
collecting, by a server computer, individual playout statistics corresponding to playout of advertisements from at least one advertising insertion computer systems;
organizing, by the server computer, the individual playout statistics into groups, each group having a group identifier;
calculating, by the server computer, aggregated playout statistics for each group, the aggregated playout statistics comprising a first statistic calculated for the group;
generating, by the server computer, display information for a displayable grid of blocks, each block displays the group identifier and at least one of the aggregated playout statistics for a respective group, wherein the size and position of the block in the grid depends on the first statistic; and
transmitting, by the server computer, the display information to a client device to display the grid.

2. The method of claim 1 wherein the aggregated playout statistics further comprise a second statistic calculated for the group and the color of the block corresponding to a respective group depends on the second statistic.

3. The method of claim 1 wherein the groups are channel groups and the aggregated playout statistics for each channel group correspond to a single broadcast network.

4. The method of claim 2 wherein the groups are zone groups and the aggregated playout statistics for each zone group corresponds to the aggregated playout statistics for a plurality of channel groups or for a plurality of broadcast networks.

5. The method of claim 3 wherein the groups are market groups and the aggregated playout statistics for each market group corresponds to the aggregated playout statistics for a plurality of zone groups.

6. The method of claim 3 wherein the groups are region groups and the aggregated playout statistics for each region group corresponds to the aggregated playout statistics for a plurality of zone groups.

7. The method of claim 1 further comprising:
defining, by the server computer, a plurality of levels;
organizing, by the server computer, the individual playout statistics into groups at each level, each group at each level having a group identifier;
calculating, by the server computer, the aggregated playout statistics for each group at each level, the aggregated playout statistics comprising the first statistic calculated for the group;
receiving a request to display the aggregated playout statistics for the groups at a selected level;
generating, by the server computer, the display information for the displayable grid of blocks for the selected level, each block displays the group identifier and at least one of the aggregated playout statistics for a respective group, wherein the size and position of the block in the grid depends on the first statistic; and
transmitting, by the server computer, the display information to the client device to display the grid.

8. A computer program product, tangibly embodied in a non-transitory, machine-readable storage device, for presenting advertisement playout summary in an interactive display, the computer program product including instructions being operable to cause a data processing apparatus to:
collect individual playout statistics corresponding to playout of advertisements from at least one advertising insertion computer systems;
organize the individual playout statistics into groups, each group having a group identifier;
calculate aggregated playout statistics for each group, the aggregated playout statistics comprising a first statistic calculated for the group;
generate display information for a displayable grid of blocks, each block displays the group identifier and at least one of the aggregated playout statistics for a respective group, wherein the size and position of the block in the grid depends on the first statistic; and
transmit the display information to a client device to display the grid.

9. The computer program product of claim 8 wherein the aggregated playout statistics further comprise a second statistic calculated for the group and the color of the block corresponding to a respective group depends on the second statistic.

10. The computer program product of claim 8 further comprising instructions being operable to cause a data processing apparatus to:
define a plurality of levels;
organize the individual playout statistics into groups at each level, each group at each level having a group identifier;
calculate the aggregated playout statistics for each group at each level, the aggregated playout statistics comprising the first statistic calculated for the group;
receive a request to display the aggregated playout statistics for the groups at a selected level;
generate the display information for the displayable grid of blocks for the selected level, each block displays the group identifier and at least one of the aggregated playout statistics for a respective group, wherein the size and position of the block in the grid depends on the first statistic; and
transmit the display information to the client device to display the grid.

11. A computerized server apparatus for presenting advertisement playout summary in an interactive display, comprising:
a processor configured to collect individual playout statistics corresponding to playout of advertisements from at least one advertising insertion computer systems;
the processor further configured to organize the individual playout statistics into groups, each group having a group identifier;
the processor further configured to calculate aggregated playout statistics for each group, the aggregated playout statistics comprising a first statistic calculated for the group;
the processor further configured to generate display information for a displayable grid of blocks, each block displays the group identifier and at least one of the aggregated playout statistics for a respective group, wherein the size and position of the block in the grid depends on the first statistic; and
transmit the display information to a client device to display the grid.

12. The computerized server apparatus of claim 11 wherein the aggregated playout statistics further comprise a second statistic calculated for the group and the color of the block corresponding to a respective group depends on the second statistic.

13. The computerized server apparatus of claim 11 wherein:
the processor is further configured to define a plurality of levels;
the processor is further configured to organize the individual playout statistics into groups at each level, each group at each level having a group identifier;
the processor is further configured to calculate the aggregated playout statistics for each group at each level, the aggregated playout statistics comprising the first statistic calculated for the group;
the processor is further configured to receive a request to display the aggregated playout statistics for the groups at a selected level;
the processor is further configured to generate the display information for the displayable grid of blocks for the selected level, each block displays the group identifier and at least one of the aggregated playout statistics for a respective group, wherein the size and position of the block in the grid depends on the first statistic; and
the processor is further configured to transmit the display information to the client device to display the grid.
